(19) United States
(12) Patent Application Publication
(10) Pub. No.: US 2013/0080741 A1
(43) Pub. Date: Mar. 28, 2013

(54) HARDWARE CONTROL OF INSTRUCTION OPERANDS IN A PROCESSOR

(71) Applicants: Alexander Rabinovitch, Kfar Yona (IL); Leonid Dubrovin, Karney Shomron (IL); Amichay Amitay, Hod Hasharon (IL)

(72) Inventors: Alexander Rabinovitch, Kfar Yona (IL); Leonid Dubrovin, Karney Shomron (IL); Amichay Amitay, Hod Hasharon (IL)

(21) Appl. No.: 13/246,184

(22) Filed: Sep. 27, 2011

(51) Int. Cl. G06F 9/30; G06F 9/38

(52) U.S. Cl. 712/208; 712/241; 712/E09.028; 712/E09.045

(57) ABSTRACT

An apparatus generally having a first circuit, a second circuit and a third circuit is disclosed. The first circuit may have a counter and may be configured to adjust at least one control signal in response to a current value of the counter. The first circuit may be implemented only in hardware. The counter generally counts a number of loops in which a plurality of instructions are executed. The second circuit may be configured to set the counter to an initial value. The third circuit may be configured to execute the instructions using a plurality of data items as a plurality of operands such that at least two of the instructions use different ones of the operands. The data items may be routed to the third circuit in response to the control signal. The apparatus generally forms a processor.

### FIELD OF THE INVENTION

The present invention relates to vector digital signal processors generally and, more particularly, to a method and/or apparatus for implementing hardware control of instruction operands in a processor.

### BACKGROUND OF THE INVENTION

Hardware loop counter (i.e., HWLC) circuits are used in modern digital signal processors (i.e., DSPs). An HWLC circuit counts in hardware a number of loop iterations executed in software. In a conventional DSP design, “LC” registers specify the number of times each loop is to be executed. Since the LC registers hold a 32-bit signed value, the largest number of loop iterations is 2³¹−1. Instructions DOEN and DOENSH are used to initialize an LC register. The HWLC circuits allow a reduction in a program size, performance penalties and power penalties associated with a program cache because the HWLC circuits allow code compaction by usage of repeating coding patterns.

The HWLC circuits continue to be implemented in the next generation of vector DSP cores. However, the HWLC circuits have become less efficient and harder to use. Modern vector DSP cores use vector instructions to increase the core processing power by operating on several data values simultaneously. Consider a vector register V that includes sixteen 16-bit values. An instruction “MPY.16 V0.0, V1.0:V1.15, V5” multiplies 16 short values stored in V1 by a value stored in V0.0 and subsequently stores 16 short values of the results into V5. Similarly, an instruction “MAC.16 V0.0, V1, V5” performs a multiply-and-accumulate instruction on the 16 short values stored in V1 by the value stored in V0.0.

An example 16-tap finite impulse response filter (i.e., FIR) using the MAC and the MPY instructions is conventionally implemented as follows:

| | |
|---|---|
| LOAD (r0)+,V0 | ;Bring 16 coefficients data into V0. |
| LOAD (r1)+,V1:V2 | ;Bring 32 data points to V1:V2 used |
| | ;to calculate the 16 results. |
| MPY.16 V0.0, V1.0:V1.15, V5 | ;Multiply 16 data points 0...15 by |
| | ;first coefficient located in V0.0. |
| MAC.16 V0.1, V1.1:V2.0, V5 | ;Multiply 16 data points 1...16 by |
| | ;the second coefficient located in |
| | ;V0.1 and add the data to the |
| | ;accumulated result. |
| MAC.16 V0.2, V1.2:V2.1,V5 | ;Multiply 16 data points 2...17 by |
| | ;the third coefficient located in |
| | ;V0.2 and add the data to the |
| | ;accumulated result. |
| ... | |
| MAC.16 V0.15,V1.15:V2.14,V5 | ;Multiply last 16 data points 15...30 |
| | ;by the last coefficient located in |
| | ;V0.15 and add the data to the |
| | ;accumulated result. |
| STORE V5, (r2)+ | ;Store 16 outputs from V5 to memory. |

Due to the vector nature of the operations in the conventional FIR filter, the data for every instruction is explicitly defined within the corresponding instruction. Each instruction is unique and therefore the hardware loops cannot be used. In addition, the example code uses a significant memory allocation and spends valuable instruction encoding space because all of the instruction operands are explicitly defined for the functionality.

It would be desirable to implement hardware control of instruction operands in a processor.

### SUMMARY OF THE INVENTION

The present invention concerns an apparatus generally having a first circuit, a second circuit and a third circuit. The first circuit may have a counter and may be configured to adjust at least one control signal in response to a current value of the counter. The first circuit may be implemented only in hardware. The counter generally counts a number of loops in which a plurality of instructions are executed. The second circuit may be configured to set the counter to an initial value. The third circuit may be configured to execute the instructions using a plurality of data items as a plurality of operands such that at least two of the instructions use different ones of the operands. The data items may be routed to the third circuit in response to the control signal. The apparatus generally forms a processor.

The objects, features and advantages of the present invention include providing a method and/or apparatus for implementing hardware control of instruction operands in a processor that may (i) use hardware counters as implicit control operands during instruction decoding, (ii) use the hardware counters as implicit control operands during pipelined operations, (iii) use modulo counting for the instruction decoding, (iv) use offset values for the instruction decoding and/or (v) be implemented in a vector digital signal processor.

### BRIEF DESCRIPTION OF THE DRAWINGS

These and other objects, features and advantages of the present invention will be apparent from the following detailed description and the appended claims and drawings in which:

FIG. 1 is a block diagram of an example implementation of an apparatus;

FIG. 2 is a block diagram of a processor core in accordance with a preferred embodiment of the present invention;

FIG. 3 is a block diagram of an example implementation of a hardware loop counter circuit; and

FIG. 4 is a block diagram of another example implementation of the hardware loop counter circuit.

### DETAILED DESCRIPTION OF THE PREFERRED EMBODIMENTS

Some embodiments of the present invention may implement hardware loop counter values as implicit control signals to select program instruction operands during program instruction decoding and/or operation. Information about the loop iterations may be passed from the hardware counter to an instruction decoder. Use of the hardware loop counter values to control the operands for the instructions generally allows for simplification of instruction encoding and may dramatically reduce the code size. For example, an implementation of the example 16-tap finite impulse response filter per some embodiments of the present invention may be as follows:

| | |
|---|---|
| LOAD (r0)+,V0 | ;Bring 16 coefficients data into V0. |
| LOAD (r1)+,V1:V2 | ;Bring 32 data points to V1:V2 |
| | ;to calculate the 16 results. |
| CLR V5 | ;Zero V5 registers. |
| DOENSH #16 | ;Execute loop 16 times. |

| | |
|---|---|
| MAC_HWLC.16 V0.HWLC, V1:V2,V5 | ;Multiply 16 data |
| | points |
| | ;HWLC:HWLC+15 by |
| | first |
| | ;coefficient located |
| | in V0.HWLC. |

| | |
|---|---|
| STORE V5,(r2)+ | ;Store 16 outputs from V5 to memory. |

After the coefficients and data points have been loaded, the program code of the example implementation uses only three instructions: clear (e.g., CLR), loop (e.g., DOENSH #16) and multiply-and-accumulate (e.g., MAC_HWLC.16). In contrast, the conventional example implementation uses 16 multiply/multiply-and-accumulate instructions, which is more than five times the code size and has higher program cache penalties.

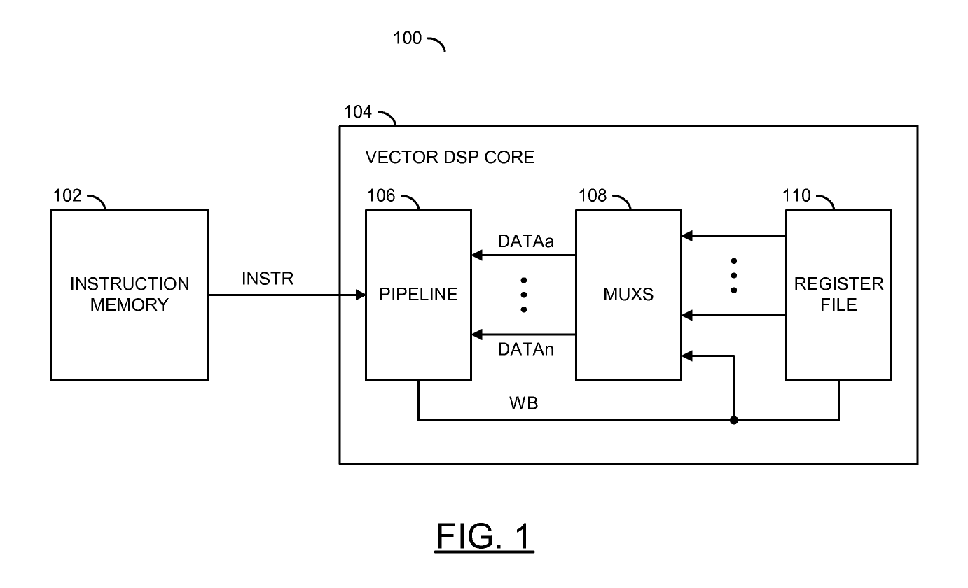

Referring to FIG. 1, a block diagram of an example implementation of an apparatus 100 is shown. The apparatus (or circuit or device or integrated circuit) may implement a vector digital signal processor (e.g., DSP) with an associated instruction memory. The apparatus 100 generally comprises a block (or circuit) 102 and a block (or circuit) 104. The circuit 104 generally comprises a block (or circuit) 106, a block (or circuit) 108 and a block (or circuit) 110. The circuits 102-110 may represent modules and/or blocks that may be implemented as hardware, software, a combination of hardware and software, or other implementations. In some embodiments, the circuits 102, 108 and 110 may be implemented only in hardware (or dedicated hardware).

An instruction signal (e.g., INSTR) may be generated by the circuit 102 and received by the circuit 106. A write back signal (e.g., WB) may be generated by the circuit 106 and received by the circuits 108 and 110. Multiple data signals (e.g., DATAa-DATAn) may be routed from the circuit 110, through the circuit 108 to the circuit 106.

The circuit 102 may implement an instruction memory. The circuit 102 may be operational to store instructions (software programs) to be executed by the circuit 104. The instructions may be presented by the circuit 102 to the circuit 104 in the signal INSTR. In some embodiments, the circuit 102 may be fabricated on a die (or chip) separate from the circuit 104. In other embodiments, the circuit 102 may be fabricated on the same die (or chip) as the circuit 104. In still other embodiments, the circuit 102 may implement an instruction cache memory and is part of the circuit 104.

The circuit 104 may implement a vector DSP circuit. The circuit 104 is generally operational to execute the instructions received from the circuit 102 via the signal INSTR. Many instructions may have associated operands (or data items) consumed during the instruction execution and/or operands (or data items) generated by the instruction execution. Data items consumed during the execution may be transferred internal to the circuit 104 from storage units (or elements) to execution units (or elements) in the signals DATAa-DATAn. Data items created by the instruction execution in the execution units may be written back into the storage units in the signal WB.

The circuit 106 may implement a pipeline circuit. The circuit 106 is generally operational to execute (or process) the instructions received from the circuit 102. Data items consumed by and generated by the instructions may also be read (or loaded) from the circuit 110 via the signals DATAa-DATAn and written (or stored) back to the circuit 110 in the signal WB. In some embodiments, the pipeline may implement a hardware pipeline. In some embodiments, the pipeline may implement a software pipeline. In other embodiments, the pipeline may implement a combined hardware and software pipeline.

The circuit 108 may implement multiple multiplexer circuits. The circuit 108 is generally operational to multiplex (or route) the data items from the circuit 110 to the circuit 106. The circuit 108 may also multiplex the data items in the signal WB back to the circuit 106. The routing performed by the circuit 108 is generally controlled by the circuit 106.

The circuit 110 may implement a register file circuit. The circuit 110 is generally operational to buffer the data items presented to and received from the circuit 106 in addressable registers and/or collections of registers. The data items stored in the circuit 110 may include operands associated with some instructions executed by the circuit 106.

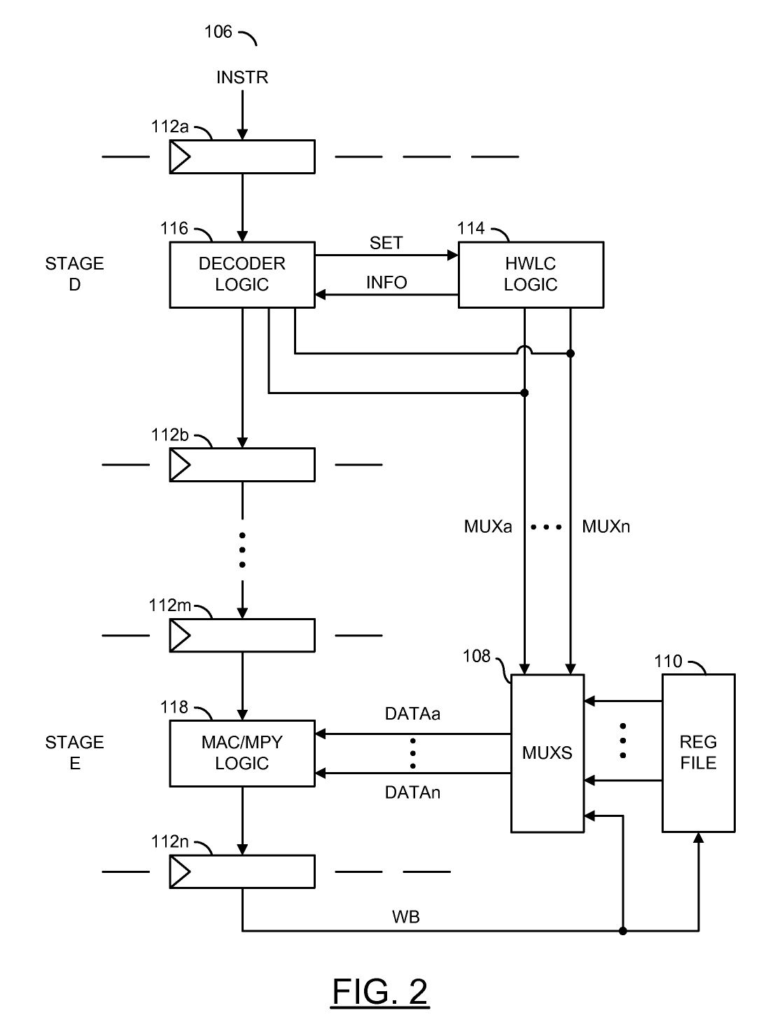

Referring to FIG. 2, a block diagram of the circuit 106 is shown in accordance with a preferred embodiment of the present invention. The circuit 106 may implement a multi-stage pipeline (e.g., P, R, F, V, D, G, A, C, S, M, E and W). Other numbers of the stages and other arrangements of the stages may be implemented to meet the criteria of a particular application. Each stage may be connected to the adjoining stages by one or more registers (or circuits) 112a-112n.

The stage P may implement a program address stage. During the stage P, the fetch set of addresses may be driven to enable the memory read process. While the address is being issued from the circuit 106 to the circuit 102, the stage P may update a fetch counter for the next program memory read.

The stage R may implement a read memory stage. In the stage R, the circuit 106 may access the circuit 102 for the program instructions.

The stage F may implement a fetch stage. During the stage F, the circuit 102 generally sends the instruction set to the circuit 104. The circuit 104 may write the instruction set to local registers (e.g., circuit 110).

The stage V may implement a variable-length execution set (e.g., VLES) dispatch stage. During the stage V, the circuit 106 may displace the VLES instructions to the different execution units within the circuit 104. The circuit 106 may also decode the prefix instructions in the stage V.

The stage D may implement a decode stage. During the stage D, the circuit 106 may decode the instructions received from the circuit 102. A block (or circuit) 114 and a block (or circuit) 116 may be associated with the state D.

The stage G may implement a generate address stage. During the stage G, the circuit 106 may precalculate a stack pointer and a program counter. The circuit 106 may generate a next address for both one or more data address (for load and for store) operations and a program address (e.g., change of flow) operation.

The stage A may implement an address to memory stage. During the stage A, the circuit 106 may send the data address to a data memory. The circuit 106 may also process arithmetic instructions, logic instructions and/or bit-masking instructions (or operations).

The stage C may implement an access memory stage. During the stage C, the circuit 106 may access the data memory for load (read) operations.

The stage S may implement a sample memory stage. During the stage S, the data memory may send the requested data to the circuit 106.

The stage M may implement a multiply stage. During the stage M, the circuit 106 may process and distribute the read data. The circuit 106 may also perform an initial portion of a multiply-and-accumulate execution. The circuit 106 may also move data between the registers during the stage M.

The stage E may implement an execute stage. During the stage E, the circuit 106 may complete another portion of any multiply-and-accumulate execution already in progress. Multiply executions may also be performed in the stage E. The circuit 106 may complete any bit-field operations still in progress. The circuit 106 may complete any ALU operations in progress.

The stage W may implement a write back stage. During the stage W, the circuit 106 may return any write data generated in the earlier stages the circuit 110 via the signal WB.

The circuits 104/106 may include a block (or circuit) 114, a block (or circuit) 116 and a block (or circuit) 118. The circuits 116-118 may represent modules and/or blocks that may be implemented as hardware, software, a combination of hardware and software, or other implementations. The circuit 114 may be implemented only in hardware (or dedicated hardware).

The circuit 116 may receive the signal INSTR via the register 112a. A signal (e.g., SET) may be generated by the circuit 116 and received by the circuit 114. A signal (e.g., INFO) may be generated by the circuit 114 and returned to the circuit 116. Multiple control signals (e.g., MUXa-MUXn) may be generated by the circuit 114 and/or the circuit 116 and transferred to the circuit 108.

The circuit 114 may implement a hardware loop counter (e.g., HWLC) circuit. The circuit 114 is generally operational to perform one or more loop counts for various instructions (e.g., instruction MAC_HWLC.16 V0.HWLC, V1:V2,V5) being decoded by the circuit 116. Setup for each loop count may be controlled by data received in the signal SET. Each loop counter generally counts a number of loops in which designated instructions may be executed by the circuit 106. Information about the status of the loop iterations may be presented in the signal INFO. The circuit 114 may also be operational to generate the signals MUXa-MUXn in response to current values of the loop count values. The signals MUXa-MUXn may be adjusted to route data items from the circuit 110 through the circuit 108 to the circuit 106 (e.g., to the circuit 118). The data items may be used as operands for the one or more of the program instructions being executed by the circuit 106.

The circuit 116 may implement an instruction decoder logic circuit. The circuit 116 is generally operational to decode the program instructions executed by the circuit 106. The circuit 116 is generally associated with the decode stage (e.g., stage D) of the pipeline formed as the circuit 106. The decoding of the program instructions may include setting up the loop counters in the circuit 114 to the initial values (e.g., instruction DOENSH #16), initializing modulo values (e.g., MOVE #4,R0) and/or initializing offset values (e.g., MOVE #2,R1) via the signal SET. The loop iteration information received by the circuit 116 from the circuit 114 via the signal INFO may be used by the circuit 116 to achieve more accurate control of the program instructions.

The circuit 116 generally receives every instruction as a group of bits. The circuit 116 may decode the instructions to determine what particular operations should be executed, which one or more registers in the circuit 110 holds input data and which one or more registers in the circuit 110 may be used to store the resulting output data. The decoded information may be: used to control register multiplexing in the circuit 108 via the signals MUXa-MUXn.

Selection control among the registers and/or portions (or parts) within individual registers may be aided by the information received from the circuit 114 in the signal INFO. For example, the instruction MAC_HWLC.16 V0.HWLC,V1:V2,V5 may explicitly define the “V0” portion of the vector (or registers) “V0:HWLC” and the signal INFO may define the “HWLC” portion of the vector “V0.HWLC”. The signal INFO may provide the current loop count value (e.g., 0, 1, . . . , 15) back to the circuit 116. Therefore, the circuit 116 may control the signals MUXa-MUXn to sequentially read data items from locations V0:0, V0:1, . . . , V0:15, a different data item in each loop iteration. A decoding of the example instruction is generally described in Table 1 as follows:

TABLE 1

| Loop Iteration No. | V0: HWLC Value |
|---|---|
| 0 | V0: 0 |
| 1 | V0: 1 |
| 2 | V0: 2 |
| . . . | . . . |
| 15 | V0: 15 |

As such, encoding of the instruction MAC_HWLC.16 may be reduced by the several (e.g., 4) bits that would otherwise identify the “HWLC” portion of the vector.

In some embodiments, the circuit 108 may be designed to control multiplexing of the vector V0 through multiple signals MUXa-MUXn. For example, the circuit 116 may generate a multiplex control signal (e.g., MUXc) to generically select the entire vector V0 (e.g., n registers) from the circuit 110. The circuit 114 may generate another multiplex control signal (e.g., MUXg) to select among the n portions of the vector V0 (e.g., the individual registers V0.0, . . . , V0.15) according to the current loop count value. The signal INFO may be used by the circuit 114 to inform the circuit 116 of the current loop iteration status (e.g., count value).

In some embodiments, the circuit 114 may provide all of the multiplexing control for the vector V0. The circuit 116 may send the identify of the desired vector (e.g., V0) to the circuit 114 via the signal SET. The circuit 114 may use the received identity an the current loop count value to control one or more of the signals MUXa-MUXn to route the data from the individual registers (e.g., V0.0, . . . , V0.15) from the circuit 110 to the circuit 106. The signal INFO may be used by the circuit 114 to inform the circuit 116 of the current loop iteration status.

The circuit 118 may implement a multiply-and-accumulate (e.g., MAC) and/or a multiply (e.g., MPY) logic circuit. The circuit 118 is generally operational to execute multiply-and-accumulate instructions (e.g., MAC_HWLC.16) and/or multiply instructions (e.g., MPY.16). Operands (or data items) used in the multiplications may be received in the signal DATAa-DATAn from the circuit 110. The circuit 118 is generally associated with the execution stage (e.g., stage E) of the pipeline. Routing of the data items from the circuit 110 to the circuit 118 may be achieved by the multiplexers of the circuit 108. Selection of the data items routed from the circuit 110 may be controlled by the circuit 114 and/or the circuit 116 via the signals MUXa-MUXn. Other stages (e.g., the stage M) may include circuitry that receives the data items controlled by the circuit 114 and/or the circuit 116 via the signals MUXa-MUXn.

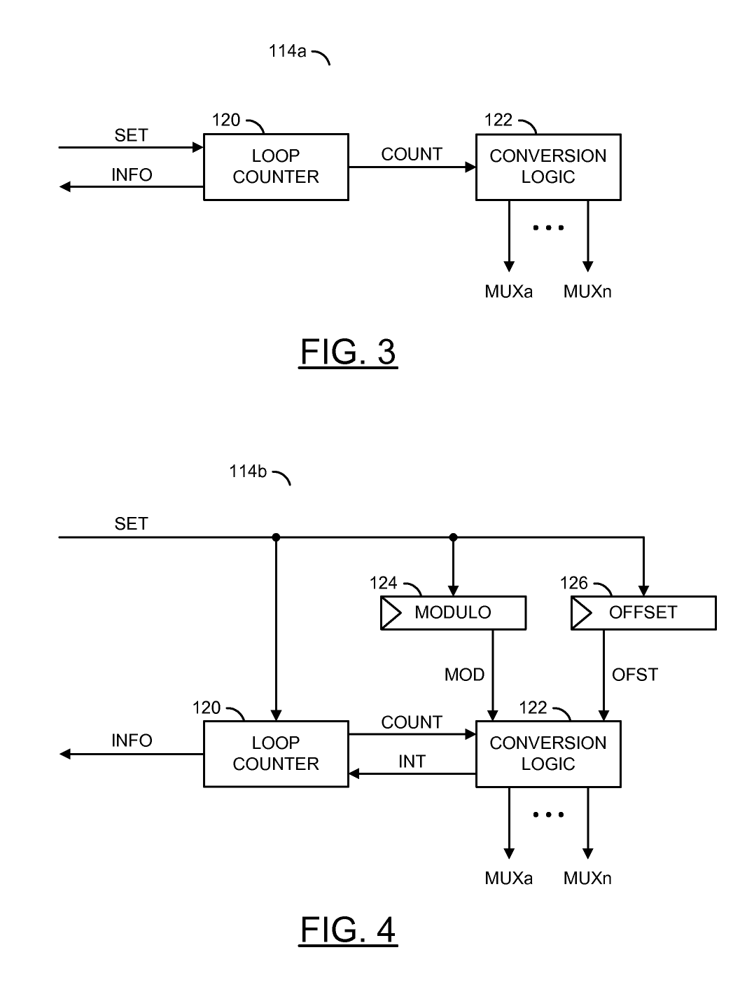

Referring to FIG. 3, a block diagram of an example implementation of a circuit 114a is shown. The circuit 114a may represent an embodiment of the circuit 114. The circuit 114a generally comprises a block (or circuit) 120 and a block (or circuit) 122. The circuits 120-122 may represent modules and/or blocks that may be implemented as hardware, software, a combination of hardware and software, or other implementations. In some embodiments, the circuits 120-122 may be implemented only in hardware (or dedicated hardware).

The signal SET may be received by the circuit 120. The circuit 120 may generate the signal INFO. A signal (e.g., COUNT) may be generated by the circuit 120 and receive by the circuit 122. The circuit 122 may generate the signals MUXa-MUXn.

The circuit 120 may implement a loop counter circuit. The circuit 120 is generally operational to run one or more loop counters. The circuit 120 generally stores the number of loop iterations that should be executed for each loop counter. The numbers may be updated via the signal SET from the circuit 116. The circuit 116 may obtain the numbers by decoding enable instructions (e.g., DOENSH). The loop counters may be programmed to count up or count down. After execution of each iteration, the number of executed iterations may be incremented (or decremented) until the corresponding programmed number is reached. A current count value for each of the loop counters may be presented in the signal COUNT to the circuit 122. The loop iteration information may be generated by the circuit 120 in the signal INFO. The loop iteration information generally conveys the current count values and/or when the loops expire. When the loop execution is completed, liner code execution generally continues in the circuit 106.

The circuit 122 may implement a count conversion logic circuit. The circuit 122 is generally operational to adjust the signals MUXa-MUXn based on the count values received in the signal COUNT. Control of the signals MUXa-MUXn by the circuit 114 (122) may enable decoded instructions to obtain operands (e.g., the various data items) from the circuit 110 without having the location of the operands explicitly encoded into the instructions.

Referring to FIG. 4, a block diagram of an example implementation of a circuit 114b is shown. The circuit 114b may represent an embodiment of the circuit 114. The circuit 114b generally comprises the circuit 120, the circuit 122, one or more registers (or circuits) 124 and one or more registers (or circuits) 126. The circuit 122 may generate a signal (e.g., INT) that is transferred to the circuit 120. The signal SET may be received by the circuits 120, 124 and 126. The circuit 124 may generate a modulo signal (e.g., MOD) received by the circuit 122. The circuit 126 may generate an offset signal (e.g., OFST) received by the circuit 122. In some embodiments, the circuits 124 and 126 may be implemented as part of the circuit 110.

In addition to the loop counters, the circuit 114b may include the circuits 124 and 126 to buffer one or more modulo values and one or more offset values, respectively. The modulo values and the offset values may be transferred to the circuits 124 and 126 via the signal SET. The offset values received in the signal OFST generally allow the circuit 122 to modify the current count values by known (and programmable) offset values. For example, the circuit 122 may generate an offset count value by adding an offset value to a current count value. The offset counter values may be presented in the signal INT back to the circuit 120. The circuit 120 may subsequently present the offset counter values and the current counter values back to the circuit 116 in the signal INFO. The offset count values may also be used in place of the current count values received in the signal COUNT to control the signals MUXa-MUXn.

The modulo values received in the signal MOD generally allow the circuit 122 to modify the current count values by known (and programmable) modulo operations. For example, to execute the same program instructions on every n-th (e.g., 8th) iteration of a loop, a corresponding modulo value in the register 124 may be set to the value of n. The modulo count values may be presented in the signal INT back to the circuit 120. The circuit 120 may present the modulo count value and the current count value back to the circuit 116 in the signal INFO. The modulo count values may also be used in place of the current count values in the signal COUNT to control the signals MUXa-MUXn. The offset values and/or the modulo values generally allow for more control of the program instructions compared with the basic counter values.

Returning to the example instruction MAC_HWLC.16 V0.HWLC,V1:V2,V5, an order of the operands may be altered by the modulo value and/or the offset value. A module value (e.g., 4) may be stored in the circuit 124 by a move instruction (e.g., MOVE #4,R0), where the circuit 124 is implemented as a general register R0 in the circuit 104. An offset value (e.g., 2) may be stored in the circuit 126 by a move instruction (e.g., MOVE #2,R1), where the circuit 126 is implemented as a general register R1 in the circuit 104. After the modulo value and the offset value have been programmed, the 16-count loop may be enabled (e.g., DOENSH #16) Therefore, decoding of the example instruction is generally described in Table 2 as follows:

TABLE 2

| Loop Iteration No. | V0: HWLC Value | Comments |
|---|---|---|
| 0 | V0.2 | The operation may start with |
| | | the offset value. |
| 1 | V0.3 | |
| 2 | V0.0 | The count may restart on the |
| | | modulo value. |
| 3 | V0.1 | |
| 4 | V0.2 | |
| 5 | V0.3 | |
| 6 | V0.0 | The count may restart on the |
| | | modulo value. |
| 7 | V0.1 | |
| 8 | V0.2 | |
| . . . | . . . | |
| 15 | V0.1 | |

The functions performed by the diagrams of FIGS. 1-4 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a first circuit having a counter and configured to adjust at least one control signal in response to a current value of said counter, wherein (i) said first circuit is implemented only in hardware and (ii) said counter counts a number of loops in which a plurality of instructions are executed;
a second circuit configured to set said counter to an initial value; and
a third circuit configured to execute said instructions using a plurality of data items as a plurality of operands such that at least two of said instructions use different ones of said operands, wherein (i) said data items are routed to said third circuit in response to said control signal and (ii) said apparatus forms a processor.

2. The apparatus according to claim 1, wherein said first circuit is further configured to transfer information about an iteration of said loop to said second circuit.

3. The apparatus according to claim 2, wherein said first circuit is further configured to generate said information in response to a modulo of said current value of said counter.

4. The apparatus according to claim 2, wherein said first circuit is further configured to generate said information in response to an offset value relative to said current value of said counter.

5. The apparatus according to claim 1, wherein said first circuit is further configured to adjust said control signal in further response to a modulo of said current value of said counter.

6. The apparatus according to claim 1, wherein said first circuit is further configured to adjust said control signal in further response to an offset value relative to said current value of said counter.

7. The apparatus according to claim 1, wherein said second circuit is further configured to decode said instructions.

8. The apparatus according to claim 1, wherein said third circuit is further configured to multiply at least two of said operands.

9. The apparatus according to claim 1, wherein said apparatus forms part of a vector digital signal processor.

10. The apparatus according to claim 1, wherein said apparatus is implemented as one or more integrated circuits.

11. A method for hardware control of operands in a processor, comprising the steps of;
(A) setting a counter in a first circuit of said processor to an initial value from a second circuit of said processor, wherein (i) said first circuit is implemented only in hardware and (ii) said counter counts a number of loops in which a plurality of instructions are executed;
(B) adjusting at least one control signal with said first circuit in response to a current value of said counter; and
(C) routing a plurality of data items to a third circuit of said processor in response to said control signal, wherein said third circuit is configured to execute said instructions using said data items as said operands such that at least two of said instructions use different ones of said operands.

12. The method according to claim 11, further comprising the step of:
transferring information about an iteration of said loop from said first circuit to said second circuit.

13. The method according to claim 12, further comprising the step of:
generating said information in response to a modulo of said current value of said counter.

14. The method according to claim 12, further comprising the step of:
generating said information in response to an offset value relative to said current value of said counter.

15. The method according to claim 11, further comprising the step of:
adjusting said control signal in further response to a modulo of said current value of said counter.

16. The method according to claim 11, further comprising the step of:
adjusting said control signal in further response to an offset value relative to said current value of said counter.

17. The method according to claim 11, further comprising the step of:
decoding said instructions using said second circuit.

18. The method according to claim 11, further comprising the step of:
multiplying at least two of said operands using said third circuit.

19. The method according to claim 11, wherein said method is implemented in a vector digital signal processor.

20. An apparatus comprising:
means for setting a counter in a first circuit of a processor to an initial value from a second circuit of said processor, wherein (i) said first circuit is implemented only in hardware and (ii) said counter counts a number of loops in which a plurality of instructions are executed;
means for adjusting at least one control signal with said first circuit in response to a current value of said counter; and
means for routing a plurality of data items to a third circuit of said processor in response to said control signal, wherein said third circuit is configured to execute said instructions using said data items as a plurality of operands such that at least two of said instructions use different ones of said operands.
